(19) United States
(12) Patent Application Publication
(10) Pub. No.: US 2026/0342821 A1
(43) Pub. Date: Oct. 29, 2026

(54) Agent External IP Address Association

(71) Applicant: Palo Alto Networks, Inc., Santa Clara, CA (US)

(72) Inventors: Or Kliger, Ramat Gan (IL); Eden Elazar, Haifa (IL); Dror Alon, Rishon Lezion (IL); Aviad Meyer, Hod-Hasharon (IL); Zohara Zigdon, Ra’anana (IL)

(21) Appl. No.: 19/188,042

(22) Filed: Apr. 24, 2025

(51) Int. Cl. H04L 9/40

(52) U.S. Cl. CPC H04L 63/1425; H04L 63/1441

(57) ABSTRACT

A method, including receiving, from first resources deployed at first IP addresses, first logs detailing events occurring on the first resources during a first period. Respective labels are received for the first addresses indicating whether each first address is shared or non-shared. Based on the events and the labels, a model is trained for classifying the first addresses as shared or non-shared. Second logs are received from second resources deployed at second IP addresses detailing events occurring on the second resources during a second period. The model is applied to the events during the second period so as to classify each second address as shared or non-shared, the non-shared second IP addresses corresponding to respective second resources. Upon detecting, in a given second log, any events indicating suspicious activity at a given non-shared second address, protective action is initiated on the second resource corresponding to the given second non-shared address.

### FIELD OF THE INVENTION

The present invention relates generally to computer security, and particularly to classifying public IP addresses as shared or non-shared.

### BACKGROUND OF THE INVENTION

Public and private Internet protocol (IP) addresses serve different purposes in networking. A public IP address is typically assigned by an Internet Service Provider (ISP) and is globally unique, thereby allowing devices to be identified and accessed over the Internet. Public IP addresses are typically used for devices that need to communicate directly with the Internet, such as web servers, email servers, or any devices that provide services to users over the Internet. Because public IP addresses are unique across the entire Internet, they are essential for routing traffic between different networks worldwide.

On the other hand, private IP addresses are typically used within a local network (such as a home or office network) and are therefore not routable on the public Internet. These addresses are typically assigned by a router or a Dynamic Host Configuration Protocol (DHCP) server to devices within a private network, e.g., computers and printers. Private IP addresses allow devices within the same local network to communicate with each other, while the router, acting as a gateway, uses a single public IP address to connect to the Internet. This use of private IP addresses helps conserve the limited number of available public IP addresses and adds a layer of security, as devices with private IP addresses are not directly exposed to the Internet.

Public IP addresses are either shared or non-shared. A shared public IP address is one that multiple devices or websites use simultaneously, often within a hosting environment or corporate network. Sharing a public IP address may limit customization options and make it more challenging to manage traffic or security.

In contrast, a non-shared (also known as a dedicated) IP address) is unique to a single device, server, or website, providing exclusive use and more control over online activities. Non-shared IP addresses are often used by businesses that require enhanced security, reliability, and performance, such as e-commerce websites or organizations handling sensitive data.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method including receiving, from a set of first computing resources deployed at a plurality of first Internet Protocol (IP) addresses, first logs detailing events occurring on the first computing resources during a first time period, receiving respective labels for the first IP addresses indicating whether each of the first IP addresses is shared or non-shared, training, by a processor based on the events during the first time period and the received labels, a model for classifying the first IP addresses as either shared or non-shared, receiving, from a set of second computing resources deployed at a plurality of second IP addresses, second logs detailing events occurring on the second computing resources during a second time period, applying the trained model to the events during the second time period so as to classify each of the second IP addresses as either shared or non-shared, the non-shared second IP addresses corresponding to respective second computing resources, and upon detecting, in a given second log, one or more events indicating suspicious activity at a given non-shared second IP address, initiating a protective action on the second computing resource corresponding to the given second non-shared IP address.

In one embodiment, the events indicating suspicious activity include first events, and further including upon detecting, in one of the second logs, one or more second events indicating suspicious activity at a given shared second IP address, generating a request for an investigation with respect to the given shared second IP addresses.

In another embodiment, a subset of the computing resources execute endpoint agents configured to generate respective logs.

In some embodiments, receiving respective labels for the first IP addresses includes analyzing the logs from the endpoint agents.

In an additional embodiment, the computing resources include host computers.

In a further embodiment, the computing resources include cloud computing instances.

In a supplemental embodiment, the computing resources include software as a service (SaaS) servers.

In one embodiment, training the model based on the events during the first time period and the labels includes generating first features from the events during the first time period, and training the model based on the generated features and the events, and wherein applying to the events during the second time period, includes generating second features from the events during the second time period, and applying the trained model to the second features.

In a first training embodiment, a given feature includes a number of local users detected that logged into one or more computing resources sharing at a given IP address.

In some embodiments, classifying the given IP address includes comparing the number to a threshold, classifying the given IP address as shared if the number is greater than the threshold, and classifying the given IP address as non-shared if the number is less than or equal to the threshold.

In a second training embodiment, a given feature includes a duration that a given IP address was active.

In some embodiments, classifying the given IP address includes comparing the duration to first and second thresholds, classifying the given IP address as non-shared if the duration is less than or equal to the first threshold, and classifying the given IP address as shared if the number is greater than or equal to the second threshold.

In a third training embodiment, the IP addresses include public IP addresses, and wherein a given feature includes a number of local IP addresses detected from a given public IP address.

In some embodiments, classifying the given IP address includes comparing the number to a threshold, classifying the given IP address as non-shared if the number is less than or equal to the threshold, and classifying the given IP address as shared if the number is greater than the threshold.

In a fourth training embodiment, a given feature includes a number of days a given IP address was active.

In some embodiments, classifying the given IP address includes comparing the number to a threshold, classifying the given IP address as non-shared if the number is less than or equal to the threshold, and classifying the given IP address as shared if the number is greater than the threshold.

In a fifth training embodiment, a given feature includes a number of different operating systems detected from a given IP address.

In some embodiments, classifying the given IP address includes comparing the number to a threshold, classifying the given IP address as non-shared if the number is less than or equal to the threshold, and classifying the given IP address as shared if the number is greater than the threshold.

In a sixth training embodiment, a given feature includes a number of distinct hours of the day a given IP address was active.

In some embodiments, classifying the given IP address includes comparing the number to a threshold, classifying the given IP address as non-shared if the number is less than or equal to the threshold, and classifying the given IP address as shared if the number is greater than the threshold.

In a seventh training embodiment, a given feature includes a number of application server ports that had transmissions from a given IP address.

In some embodiments, classifying the given IP address includes comparing the number to a threshold, classifying the given IP address as non-shared if the identified number is less than or equal to the threshold, and classifying the given IP address as shared if the number is greater than the threshold.

In an eighth training embodiment, a given feature includes a number of cloud domains that had transmissions 36 to or from a given IP address.

In some embodiments, classifying the given IP address includes comparing the number to a threshold, classifying the given IP address as non-shared if the number is less than or equal to the threshold, and classifying the given public IP address as shared if the identified number is greater than the threshold

In a ninth training embodiment, a given feature includes an amount of data transmitted to and received by a given IP address.

In some embodiments, classifying the given IP address includes comparing the amount to a threshold, classifying the given IP address as non-shared if the amount of data is less than or equal to the threshold, and classifying the given IP address as shared if the amount of data is greater than the threshold.

In a tenth training embodiment, a given feature includes a number of Domain Name System (DNS) queries, from a given public IP address, conveyed for different domains.

In some embodiments, classifying the given IP address includes comparing the number to a threshold, classifying the given IP address as non-shared if the number is less than or equal to the threshold, and classifying the given IP address as shared if the number is greater than the threshold.

There is also provided, in accordance with an embodiment of the present invention, an apparatus including a memory configured to store a model, and a processor configured to receive, from a set of first computing resources deployed at a plurality of first Internet Protocol (IP) addresses, first logs detailing events occurring on the first computing resources during a first time period, to receive respective labels for the first IP addresses indicating whether each of the first IP addresses is shared or non-shared, to train, based on the events during the first time period and the received labels, the model to classify the first IP addresses as either shared or non-shared, to receive, from a set of second computing resources deployed at a plurality of second IP addresses, second logs detailing events occurring on the second computing resources during a second time period, to apply the trained model to the events during the second time period so as to classify each of the second IP addresses as either shared or non-shared, the non-shared second IP addresses corresponding to respective second computing resources, and upon detecting, in a given second log, one or more events indicating suspicious activity at a given non-shared second IP address, to initiate a protective action on the second computing resource corresponding to the given second non-shared IP address.

There is additionally provided, in accordance with an embodiment of the present invention, a computer software product, the computer software product including a non-transitory computer-readable medium, in which program instructions are stored, which instructions, when read by a computer, cause the computer to receive, from a set of first computing resources deployed at a plurality of first Internet Protocol (IP) addresses, first logs detailing events occurring on the first computing resources during a first time period, to receive respective labels for the first IP addresses indicating whether each of the first IP addresses is shared or non-shared, to train, by a processor based on the events during the first time period and the received labels, a model for classifying the first IP addresses as either shared or non-shared, to receive, from a set of second computing resources deployed at a plurality of second IP addresses, second logs detailing events occurring on the second computing resources during a second time period, to apply the trained model to the events during the second time period so as to classify each of the second IP addresses as either shared or non-shared, the non-shared second IP addresses corresponding to respective second computing resources, and upon detecting, in a given second log, one or more events indicating suspicious activity at a given non-shared second IP address, to initiate a protective action on the second computing resource corresponding to the given second non-shared IP address.

### BRIEF DESCRIPTION OF THE DRAWINGS

The disclosure is herein described, by way of example only, with reference to the accompanying drawings, wherein:

FIG. 1 is a block diagram showing an example of a computing facility comprising a security system configured to collect logs from computing resources that communicate via public IP addresses, and to train and deploy a classification model for classifying the public IP addresses as either shared or non-shared, in accordance with an embodiment of the present invention;

FIG. 2 is a block diagram showing hardware, software and data components of a given computing resource, in accordance with an embodiment of the present invention;

FIG. 3 is a block diagram showing hardware, software and data components of the security server, in accordance with an embodiment of the present invention;

FIG. 4 is a block diagram showing data components of an event record used by the security server when training the classification model and when deploying the model to classify public IP addresses, in accordance with an embodiment of the present invention;

FIG. 5 is a block diagram showing components of classification model, in accordance with an embodiment of the present invention;

FIG. 6 is a block diagram showing data components of a classification record generated by the classification model, in accordance with an embodiment of the present invention; and

FIG. 7 is a flow diagram that schematically illustrates a method for training and deploying the classification model, in accordance with an embodiment of the present invention.

### DETAILED DESCRIPTION OF EMBODIMENTS

Organizations typically configure their internal data networks to communicate with public data networks (e.g., the Internet) via a single networking device such as a gateway or a router. These networking devices can deploy network address translation (NAT), virtual private network (VPN) or proxy systems that may not have a requirement or an ability to assign a distinct Internet protocol (IP) address to each endpoint on the internal data network.

When computing resources (i.e., endpoints) are coupled to internal networks that comprise this type of networking device, the computing resources typically communicate over the Internet via a single shared public IP address. This configuration can present an obstacle when analyzing event logs in order to detect any suspicious operations. This is because event logs typically contain only the public IP address from which an operation was performed. In this configuration, the IP address is a weak identifier for a given endpoint as it can be shared by multiple endpoints (i.e., thus not uniquely representing a specific endpoint).

Additionally, this configuration can complicate correlation of audit events from cloud and Software as a Service (SaaS) services to the originating endpoint, which is crucial for accurately identifying the source of audit operations. This is because caller IP addresses in the event log are typically used to perform the correlation.

Embodiments of the present invention provide methods and systems for classifying IP addresses as either shared or non-shared. As described hereinbelow, first logs detailing events occurring on the first computing resources during a first time period are received from a set of first computing resources deployed at a plurality of first Internet Protocol (IP) addresses. Respective labels for the first IP addresses are received indicating whether each first IP addresses is shared or non-shared, and based on the events during the first time period and the received labels, a model is trained (by a processor) for classifying the first IP addresses as either shared or non-shared.

Second logs are received from a set of second computing resources deployed at a plurality of second IP addresses, the second logs detailing events occurring on the second computing resources during a second time period. The trained model is applied to the events during the second time period so as to classify each of the second IP addresses as either shared or non-shared, the non-shared second IP addresses corresponding to respective second computing resources. Finally, upon detecting, in a given second log, one or more events indicating suspicious activity at a given non-shared second IP address, a protective action can be initiated on the second computing resource corresponding to the given second non-shared IP address.

As described supra, embodiments of the present invention classify each of the second IP addresses as either shared or non-shared. In these embodiments the events indicating suspicious activity comprise first events, and in instances when one or more second events indicating suspicious activity at a given shared second IP address are detected in one of the second logs, a request can be generated for an investigation with respect to the given shared second IP addresses.

As described hereinbelow, the classification model can be trained using event logs from endpoint agents deployed in a subset of the computing resources. Therefore, systems implementing embodiments of the present invention can deploy a model that uses the training data (i.e., from the endpoint agents) to enrich logs from cloud providers and SaaS servers, thereby enabling the classification of their respective IP addresses.

### SYSTEM DESCRIPTION

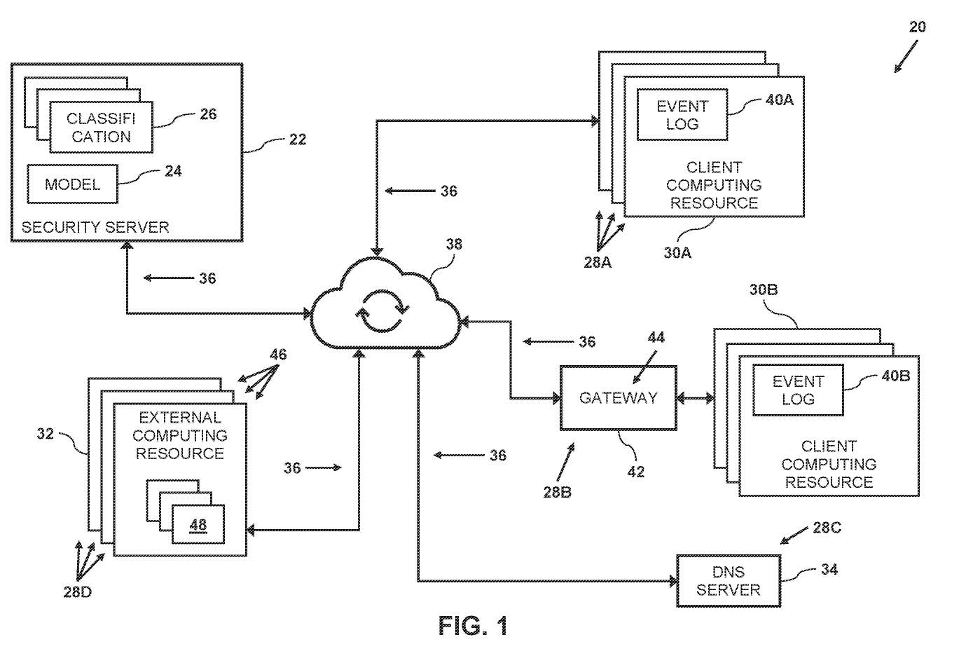

FIG. 1 is a block diagram showing an example of a computing facility 20 comprising security server 22 that is configured to train and deploy a classification model 24 configured to generate respective classifications 26 for IP addresses 28, in accordance with an embodiment of the present invention. In embodiments described herein the classifications indicate whether each IP address 28 is shared or non-shared.

In the configuration shown in FIG. 1, in addition to security server 22, computing facility 20 also comprises a plurality of client computing resources 30, a set of external computing resources 32 and a Domain Name System (DNS) server 34 that can all (i.e., including the security server) communicate with each other via transmissions 36 over a public network such as Internet 38. Examples of client computing resources 30 and external computing resources 32 include, but are not limited to, host computing devices, cloud computing instances/resources and SaaS servers.

Client computing resources 30 comprise respective event logs 40 that store details of events (typically comprising multiple operations) performed by the respective client computing resources. As described hereinbelow, security server 22 can generate classification model 24 by analyzing the event in event logs 40.

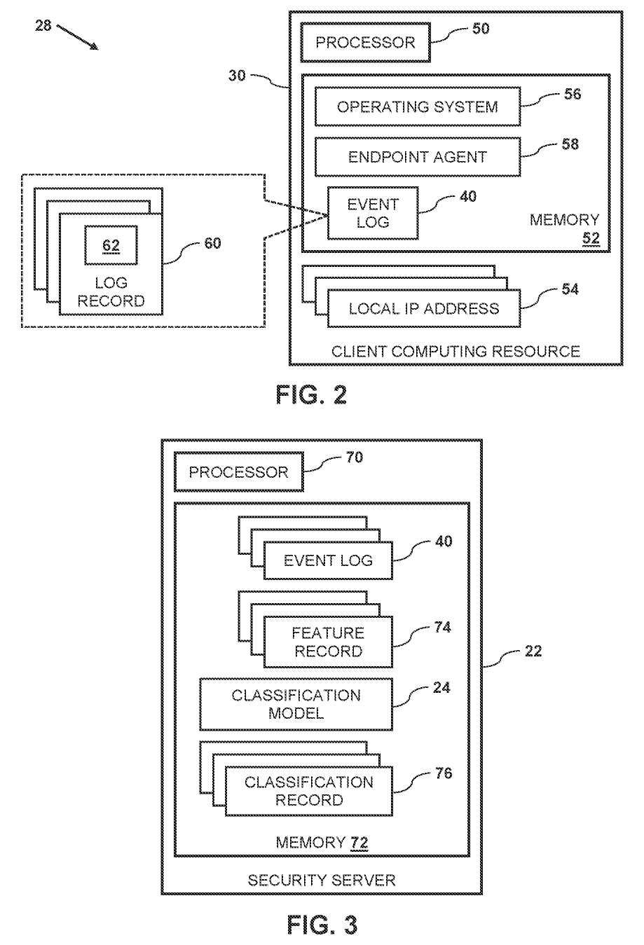

Examples of event logs 40 include cloud event logs (from a cloud infrastructure such as AMAZON WEB SERVICES^{TM}, provided by AMAZON.COM, INC., 410 Terry Avenue North, Seattle, WA, USA), SaaS event logs (e.g., for an email service such as OUTLOOK^{TM}, produced by MICROSOFT CORPORATION, One Microsoft Way, Redmond, WA, USA) or endpoint agent logs. Endpoint agents are described in the description referencing FIG. 2 hereinbelow.

Client computing resources 30 and external computing resources 32 communicate over Internet 38 using respective public IP addresses 28.

In FIG. 1, client computing resources 30, event logs 40 and public IP addresses 28 can be differentiated by appending a letter to the identifying numeral, so that the client computing resources comprise client computing resources 30A and 30B, the event logs comprise event logs 40A and 40B, and public IP addresses 28 comprise public IP addresses 28A-28D. In the configuration shown in FIG. 1:
Client computing resources 30A generate events logs 40A.
Client computing resources 30B generate event logs 40B.
Client computing resources 30A communicate with Internet 38 via respective public IP addresses 28A. In some embodiments, IP addresses 28A are non-shared IP addresses, as each client computing resource 30A comprises a respective distinct IP address 28A.
Client computing resources 30B communicate with Internet 38 via a gateway 42. In some embodiments, gateway 42 comprises a gateway service 44 such as a virtual private network (VPN), a proxy or a network address translation (NAT) service. In these embodiments, client computing resources communicate with Internet 38 using (a single) IP address 28B, which is a shared IP address (i.e., shared by resources 30B).
DNS server communicates with Internet 38 via public IP addresses 28C.
External computing resources 32 comprise respective domains 46 (also known as domain names), and communicate with Internet 38 via respective public IP addresses 28D.

DNS server 34 is typically configured to receive, from client computing resources 30, transmissions 38 comprising DNS requests to resolve a given domain 46 to its corresponding public IP address 28D.

External computing resources 32 comprise respective sets of application server ports 48. Application server ports 48 are network endpoints used by external computing resources 32 (i.e., servers) to communicate with client computing resources 30 or other external computing resources 32. They can be configured to manage access, improve security, and optimize application performance. Examples of commonly utilizing application server ports 48 are 80 for Hypertext Transfer Protocol (HTTP) or 443 for Hypertext Transfer Protocol Secure (HTTPS).

FIG. 2 is a block diagram showing hardware, software and data components of a given client computing resource 30, in accordance with an embodiment of the present invention. In the configuration shown in FIG. 2, the given client computing resource comprises a resource processor 50, a resource memory 52 and one or more local IP addresses 54.

The public IP addresses described supra are distinct identifiers assigned to computing entities (e.g. computing resources 30 and 32) on Internet 38, allowing them to communicate with other devices across different networks. Local IP addresses 54 are typically IP addresses assigned to devices within a local area network (not shown), allowing them to communicate with other devices on the same network. Local IP addresses 54 are typically not accessible from outside the local area network and are typically used for internal data exchange and resource sharing. For example, local IP addresses 54 may be assigned to physical devices such as network interface cards or logical entities such as virtual machines.

Memory 52 may comprise an operating system 56, an endpoint agent 58 and a given event log 40. An example of operating system 56 that processor 50 can execute from memory 52 is the WINDOWS^{TM} operating system produced by MICROSOFT CORPORATION, One Microsoft Way, Redmond, WA, USA.

In some embodiments, endpoint agents 58 are deployed to a subset (i.e., not all) of client computing resources 30, and are configured to generate respective event logs 40. Each endpoint agent 58 (also known as an endpoint security agent or a security agent) comprises a software application that processor 50 can execute (typically in the background) in order to detect and prevent security threats, such as malware, unauthorized access, and data breaches. One example of endpoint security agent 58 is CORTEX XDR^{TM} produced by PALO ALTO NETWORKS INC., 3000 Tannery Way, Santa Clara, CA 95054 USA).

In the configuration shown in FIG. 2, the given event log may comprise a set of log records 60 having a one-to-one correspondence with events performed by the given computing resource. Each event record comprises event data 62 about the corresponding event.

The following are examples of events that processor 50 can record in log records 60:
Retrieving an object (e.g., a file) from a given external computing resource 32 such as a cloud server.
Creating a new virtual machine in a given external computing resource 32 such as a cloud server.
Deleting secret information from a given external computing resource 32. Examples of secret information include a password, a set of credentials (such as a username and password), and an authorization token.

In the first example described hereinabove, event data 62 may comprise information such as a first given public IP address 30 of a given client computing resource responsible for a given event, a date and time of the given event, an operation (e.g., retrieving an object), a second given public IP address 30 for the cloud server, and an object ID.

FIG. 3 is a block diagram showing an example of hardware, software and data components of security server 22, in accordance with an embodiment of the present invention. In the configuration shown in FIG. 3, security server 22 comprises a server processor 70 and a server memory 72.

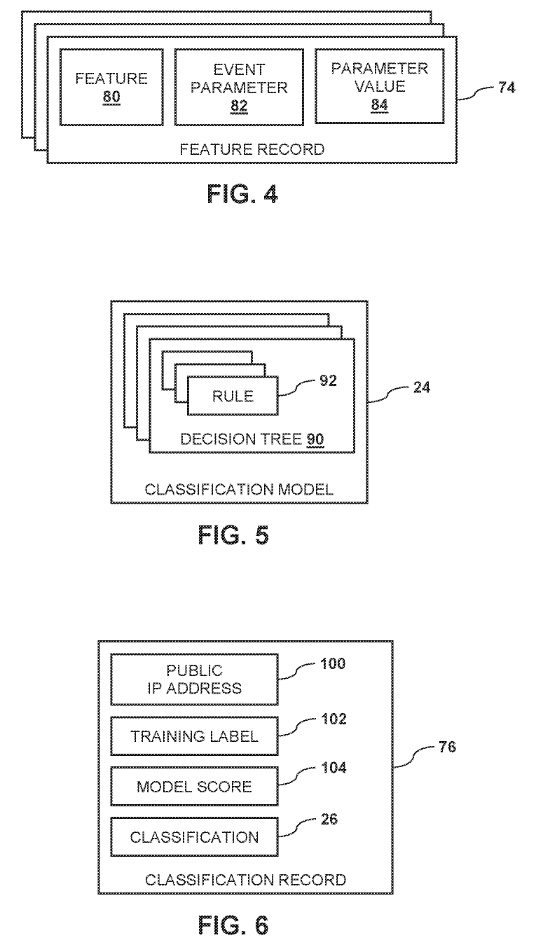

In some embodiments, memory 72 comprises classification model 24 and event logs 40 that processor 70 can receive from computing resources 30. In these embodiments, memory 72 may also comprise feature records 74 and classification records 76. Feature records 74, classification model 24 and classification records 76 are respectively described in the descriptions referencing FIGS. 4, 5 and 6 hereinbelow.

FIG. 4 is a block diagram showing an example of feature records 74 that processor 70 can use to train and deploy classification model 24, in accordance with an embodiment of the present invention.

In the example shown in FIG. 4, each feature record 74 comprises a given feature 80, an event parameter 82 and a parameter value 84. Features 80 comprise individual measurable properties or characteristics that processor 70 can extract from log records 60, and the use as input to help train classification model 24. For each given feature 80, event parameter 82 comprises a given measurable property or characteristic that processor 70 can extract from event data 62, and parameter value 84 comprises a value that the server processor can compute for the corresponding event parameter. In embodiments herein, features 80, event parameters 82 and parameter values 84 may be collectively referred to as features 80.

In embodiments described herein, processor 70 receives event logs 40 (comprising log records 60 and event data) from client computing resources 30, and stores the received event logs to memory 72. When computing parameter values 84, processor 70 can analyze the log records comprising events during a specific time period (e.g., 7, 14 or 30 days).

The following are examples of features 80 processor 70 can extract from event data 62 in event logs 60 and use for training and deploying classification model 24:

A first example for feature 80 comprises a number of local users detected at a given public IP address 28A or 28B. In this example, the corresponding parameter value stores the given public IP address, and processor 70 can compute the corresponding parameter value by identifying how many distinct users (i.e., user IDs) were logged into one or more client computing resources 30 using the given public IP address. In a first embodiment of this example, processor 70 can compute a number of distinct users that logged into a single computing resource 30 at a given public IP address 28A or 28B. In a second embodiment of this example, processor 70 can compute a number of distinct users that logged into multiple computing resources 30 sharing a given public IP address 28A or 28B. Note that in the second example, a given user may have logged into more than of the computing resources at the given public IP address.

A second example for feature 80 comprises a duration that a given public IP address 28A or 28B was active (i.e., seen in use). In some embodiment, processor 70 can specify the duration in specific time units such as hours, days or weeks. In some embodiments, processor 70 can analyze the received event logs and identify the duration as a time period starting with the earliest date that had events from the given public IP address and ending with the latest date that had events from the given public IP address. In embodiments where the duration is weeks, the corresponding parameter value stores the given public IP address, and processor 70 can compute the corresponding parameter value by identifying how many distinct (consecutive or non-consecutive) weeks had events from the given public IP address.

A third example for feature 80 comprises a number of local IP addresses 54 detected from a given public IP address 28A or 28B In this example, the corresponding parameter value stores the given public IP address, and processor 70 can compute the corresponding parameter value by identifying how many distinct local IP addresses 54 were detected in one or more client computing resources 30 using the given public IP address.

A fourth example for feature 80 comprises a number of days a given public IP address 28A or 28B was active (i.e., seen in use). In this example, the corresponding parameter value stores the given public IP address, and processor 70 can compute the corresponding parameter value by identifying how many distinct days had events from the given public IP address.

A fifth example for feature 80 comprises a number of different operating systems 56 detected from a given public IP address 28A or 28B. In this example, the corresponding parameter value stores the given public IP address, and processor 70 can compute the corresponding parameter value by identifying how many different operating systems 56 (e.g., WINDOWS^{TM}, MACOS^{TM} and LINUX^{TM}) were detected in events from the given public IP address.

A sixth example for feature 80 comprises a number of distinct hours of the day a given public IP address 28A or 28B was active (i.e., seen in use). In this example, the corresponding parameter value stores the given public IP address, and processor 70 can compute the corresponding parameter value by identifying how many distinct hours (i.e., 1-24) had events from the given public IP address.

In this example, the distinct hours typically comprise distinct hours in a given time period. For example, the given time period comprises a first day and a second day, and processor 70 detected events from a given IP address 28A or 28B during hours 8, 9 and 10 in the first day, and during hours 10, 11 and 12 in the second day. Therefore, the value for the sixth example for feature 80 is 5 (i.e., hours 8, 9, 10, 11, 12).

A seventh example for feature 80 comprises a number of distinct application server ports 48 that had transmissions 36 (i.e., connections) from a given public IP address 28A or 28B. In this example, the corresponding parameter value stores the given public IP address, and processor 70 can compute the corresponding parameter value by identifying a how many distinct application server ports 48 were detected in transmissions 36 from the given public IP address.

An eighth example for feature 80 comprises a number of cloud domains 46 that had transmissions 36 (i.e., connections) to/from a given public IP address 28A or 28B. In this example, the corresponding parameter value stores the given public IP address, and processor 70 can compute the corresponding parameter value by identifying a how many distinct cloud domains 46 were detected in transmissions 36 to/from the given public IP address.

A ninth example for feature 80 comprises an amount (i.e., a volume) of data transmitted to and received by a given public IP address 28A or 28B. In this example, the corresponding parameter value stores the given public IP address, and processor 70 can compute the corresponding parameter value by identifying a how much data (e.g., bytes, kilobytes or megabytes) were in transmissions 36 to/from the given public IP address.

A tenth example for feature 80 comprises a number of DNS queries, from a given public IP address 28A or 28B, conveyed for (i.e. to resolve) different domains 46. In this example, the corresponding parameter value stores a given domain 46, and processor 70 can compute the corresponding parameter value by identifying how many transmissions 36 (e.g., to DNS server 34) comprised DNS requests for (i.e., to resolve) the given domain.

FIG. 5 is a block diagram showing components of classification model 24, in accordance with an embodiment of the present invention. In the example shown in FIG. 5, classification model 24 comprises a set of decision trees 90, each of the decision trees comprising one or more decision rules 92. In some embodiments, processor 70 may use a random forest algorithm to generate classification model 24 from decision trees 90.

In the following are examples of decision rules 92, each of the decision rules classifies a given public IP address 28 as either shared or non-shared:

A first example of a given rule 92 is for the first example of a given feature 80 described supra. When implementing this rule, processor 70 can analyze log records 60 so as to identify a number of distinct users that were logged into one or more client computing resources 30 at the given public IP address 28, and then compare the identified number to a threshold (e.g., one). Processor 70 can then (a) classify the given public IP address as shared if the identified number is greater than the threshold, or (b) classify the given public IP address as non-shared if the identified number is less than or equal to the threshold (i.e., a single user).

A second example of a given rule 92 is for the second example of a given feature 80 described supra. In this example, duration is measured in weeks. When implementing this rule, processor 70 can analyze log records 60 so as to identify a duration for events from a given public IP address 28, and then compare the duration to a specified threshold. Processor 70 can then (a) classify the given public IP address as non-shared if the identified duration is less than or equal to the specified threshold (e.g., one or two weeks), or (b) classify the given public IP address as shared if the identified duration is greater than or equal to the specified threshold.

A third example of a given rule 92 is for the third example of a given feature 80 described supra. When implementing this rule, processor 70 can analyze log records 60 so as to identify a number of distinct local IP addresses 54 a given public IP address 28, and then compare the identified number to a threshold. Processor 70 can then (a) classify the given public IP address as non-shared if the identified number is less than or equal to the specified threshold (e.g., one), or (b) classify the given public IP address as shared if the identified number is greater than the specified threshold.

A fourth example of a given rule 92 is for the fourth example of a given feature 80 described supra. When implementing this rule, processor 70 can analyze log records 60 so as to identify a number of distinct days had events from a given public IP address 28, and then compare the number to a specified threshold. Processor 70 can then (a) classify the given public IP address as non-shared if the identified number is less than or equal to a specified threshold (e.g., seven), or (b) classify the given public IP address as shared if the identified number is greater than the specified threshold.

A fifth example of a given rule 92 is for the fifth example of a given feature 80 described supra. When implementing this rule, processor 70 can analyze log records 60 so as to identify a number of distinct operating systems 56 in events from a given public IP address 28, and then compare the number to a specified threshold. Processor 70 can then (a) classify the given public IP address as non-shared if the identified number is less than or equal to the specified threshold (e.g., 1), or (b) classify the given public IP address as shared if the identified number is greater than the specified threshold.

A sixth example of a given rule 92 is for the sixth example of a given feature 80 described supra. When implementing this rule, processor 70 can analyze log records 60 so as to identify a number of distinct hours of the day had events from a given public IP address 28, and then compare the number to a specified threshold. Processor 70 can then (a) classify the given public IP address as non-shared if the identified number is less than or equal to the specified threshold (e.g., 8, 9 or 10), and (b) classify the given public IP address as shared if the identified number is greater than the specified threshold.

A seventh example of a given rule 92 is for the seventh example of a given feature 80 described supra. When implementing this rule, processor 70 can analyze log records 60 so as to identify a number of distinct server ports 48 having transmissions 36 from a given public IP address 28, and then compare the number to a specified threshold. Processor 70 can then (a) classify the given public IP address as non-shared if the identified number is less than or equal to the specified threshold (e.g., 2, 3 or 4), or (b) classify the given public IP address as shared if the identified number is greater than the specified threshold.

An eighth example of a given rule 92 is for the eighth example of a given feature 80 described supra. When implementing this rule, processor 70 can analyze log records 60 so as to identify a number of distinct cloud domains having transmissions 36 to/from a given public IP address 28, and then compare the number to a specified threshold. Processor 70 can then (a) classify the given public IP address as non-shared if the identified number is less than or equal to the specified threshold (e.g., 2, 3 or 4), and (b) classify the given public IP address as shared if the identified number is greater than the specified threshold.

A ninth example of a given rule 92 is for the ninth example of a given feature 80 described supra. When implementing this rule, processor 70 can analyze log records 60 so as to identify an amount of data in transmissions 36 to/from a given public IP address 28, and then compare the amount to a specified threshold. Processor 70 can then (a) classify the given public IP address as non-shared if the amount of data is less than or equal to the specified threshold, and (b) classify the given public IP address as shared if the amount of data is greater than the specified threshold.

A tenth example of a given rule 92 is for the tenth example of a given feature 80 described supra. When implementing this rule, processor 70 can analyze log records 60 so as to identify a number of transmissions 36 from a given public IP address 28 that comprised DNS queries, and then compare the number to a specified threshold. Processor 70 can then (a) classify the given public IP address as non-shared if the identified number is less than or equal to the specified threshold, and (b) classify the given public IP address as shared if the identified number is greater than the specified threshold.

FIG. 6 is a block diagram showing components of a given classification record 76 generated by classification model 24, in accordance with an embodiment of the present invention. In some embodiments, processor 70 can generate classification records 76 so that there is a one-to-one correspondence between the classification records and public IP addresses 70 that the server processor detects when analyzing event logs 40 received from client computing resources 30.

In the configuration shown in FIG. 6, the given classification record comprises:
A public IP address 100 referencing a given public IP address 28.
A training label 102. When training classification model 24, training label 102 stores a "ground truth" label (i.e., shared, non-shared) for the given public address 28 referenced by public IP address 100.
A model score 104. In some embodiments, classification model 24 may compute model score 104 when applying rules 92 to even data 62 in log records 60.
Classification 26. In some embodiments, processor 70 can generate classification 26 for the (i.e., shared, non-shared) for the given public address 28 referenced by public IP address 100 based on model score 104. For example, if model score 104 meets a specified threshold, then processor 70 can classify the given public address 28 as non-shared. Likewise, if model score 104 does not meet the specified threshold, then processor 70 can classify the given public address 28 as shared.

Each of processors 50 and 70 comprise one or more general-purpose central processing units (CPU) or special-purpose embedded processors, which are programmed in software or firmware to carry out the functions described herein. This software may be downloaded to client computing resources 30 and security server 22 in electronic form, over a network, for example. Additionally or alternatively, the software may be stored on tangible, non-transitory computer-readable media, such as optical, magnetic, or electronic memory media. Further additionally or alternatively, at least some of the functions of processors 50 and 70 may be carried out by hard-wired or programmable digital logic circuits.

Examples of memories 52 and 72 include dynamic random-access memories and non-volatile random-access memories.

In some embodiments, tasks described herein performed by processor 50 and/or processor 70 may be split among multiple physical and/or virtual computing devices. In other embodiments, these tasks may be performed in a managed cloud service.

### PUBLIC IP ADDRESS CLASSIFICATION

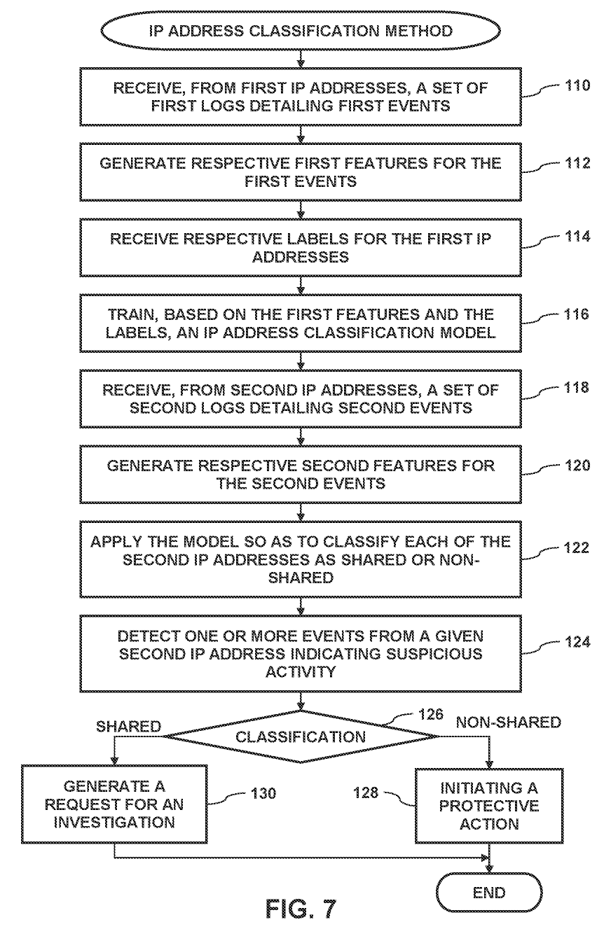

FIG. 7 is a flow diagram that schematically illustrates a method for training and deploying classification model 24, in accordance with an embodiment of the present invention.

In step 110, processor 70 receives, from a set of first client computing resources 30 deployed at a plurality of first public IP addresses 28, a set of first event logs 40, the event logs comprising respective sets of log records 60 that can have a one-to-one correspondence for first events performed by the first client computing resources during a first time period (e.g., 30 or 60 days).

In step 112, processor 70 generates respective sets of first features 80 for the first events. Examples of the first features (i.e., comprising respective event parameters 82 and parameter values 84) are described supra.

In step 114, processor 70 receives respective labels 102 for the first public IP addresses. In one embodiment, processor 70 can perform this step by analyzing logs 40 received solely from endpoint agents 58 (i.e., from client computing devices 30 comprising respective endpoint agents 58). In this embodiment, processor 70 can analyze the received logs so as to identify their respective sources (i.e., client computing resources 30). If processor 70 detects that a given public IP address 28 is in the event log received from a single endpoint agent 58 deployed at a single source, then the server processor can label (i.e., by storing a first value to the respective training level for the given public IP address) the given public IP address as non-shared. Likewise, if processor 70 detects that a given public IP address 28 is in the logs received from multiple sources, then the server processor can label (i.e., by storing a second value to the respective training level for the given public IP address) the given public IP address as shared.

In step 116, processor 70 trains, using features 80 and labels 102, classification model 24. Subsequent to training classification model 24, processor 70 can use the classification model to classify additional events from public IP addresses 28.

In step 118, processor 70 receives, from a set of second client computing resources 30 deployed at a plurality of second public IP addresses 28, a set of second event logs 40, the event logs comprising respective sets of log records 60 that can have a one-to-one correspondence for second events performed by the second client computing resources 30 during a second time period.

In one embodiment, the second client computing resources may comprise the first client computing resources, and the second public IP addresses may comprise the first public IP addresses (i.e., facility 20 as shown in FIG. 1). In another embodiment, server processor 70 can analyze log records 60 from an additional facility (not shown) having additional client computing resources 30 and additional public IP addresses 28.

In step 120, processor 70 generates respective sets of second features 80 for the second events. Examples of the second features (i.e., comprising event parameters 82 and parameter values 84) are described supra.

In step 122, processor 70 applies trained classification model 24 to the second events so as to classify each of the second public IP addresses as either shared or non-shared. In some embodiments, processor 70 can apply classification model 24 to the second events by applying the classification model to the second features of the second events.

In these embodiments, applying classification model 24 to features 80 of events for a given public IP address 28 may comprise applying decision rules 92 to the features, computing model score 104 based on the applied decision rules (e.g., using a voting algorithm), and generating classification 26 (i.e., for the given public IP address) based on the computed model score.

In step 124, processor 70 detects one or more events from a given second public IP address 28 indicating suspicious activity.

In step 126, if processor 70 detects that the classification for the given second public IP address is non-shared, then in step 128, the server processor initiates a protective action (e.g., generating an alert) for the second client computing resource deployed at the given second public IP address, and the method ends. If the classification for the given second public IP address is non-shared, then there is only a single client computing resource 30 using the given second public IP address for communication.

Returning to step 126, if processor 70 detects that the classification for the given second public IP address is shared, then in step 130, the server processor generates a request for further investigation, and the method ends. If the classification for the given second public IP address is shared, then there are multiple client computing resources 30 using the given second public IP address for communication, and further investigation is typically required to identify the client computing resource 30 responsible for the suspicious activity.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
receiving, from a set of first computing resources deployed at a plurality of first Internet Protocol (IP) addresses, first logs detailing events occurring on the first computing resources during a first time period;
receiving respective labels for the first IP addresses indicating whether each of the first IP addresses is shared or non-shared;
training, by a processor based on the events during the first time period and the received labels, a model for classifying the first IP addresses as either shared or non-shared;
receiving, from a set of second computing resources deployed at a plurality of second IP addresses, second logs detailing events occurring on the second computing resources during a second time period;
applying the trained model to the events during the second time period so as to classify each of the second IP addresses as either shared or non-shared, the non-shared second IP addresses corresponding to respective second computing resources; and
upon detecting, in a given second log, one or more events indicating suspicious activity at a given non-shared second IP address, initiating a protective action on the second computing resource corresponding to the given second non-shared IP address.

2. The method according to claim 1, wherein the events indicating suspicious activity comprise first events, and further comprising upon detecting, in one of the second logs, one or more second events indicating suspicious activity at a given shared second IP address, generating a request for an investigation with respect to the given shared second IP addresses.

3. The method according to claim 1, wherein a subset of the computing resources execute endpoint agents configured to generate respective logs.

4. The method according to claim 2, wherein receiving respective labels for the first IP addresses comprises analyzing the logs from the endpoint agents.

5. The method according to claim 1, wherein the computing resources comprise host computers.

6. The method according to claim 1, wherein the computing resources comprise cloud computing instances.

7. The method according to claim 1, wherein the computing resources comprise software as a service (SaaS) servers.

8. The method according to claim 1, wherein training the model based on the events during the first time period and the labels comprises generating first features from the events during the first time period, and training the model based on the generated features and the events, and wherein applying to the events during the second time period, comprises generating second features from the events during the second time period, and applying the trained model to the second features.

9. The method according to claim 8, wherein a given feature comprises a number of local users detected that logged into one or more computing resources sharing at a given IP address.

10. The method according to claim 9, wherein classifying the given IP address comprises comparing the number to a threshold, classifying the given IP address as shared if the number is greater than the threshold, and classifying the given IP address as non-shared if the number is less than or equal to the threshold.

11. The method according to claim 8, wherein a given feature comprises a duration that a given IP address was active.

12. The method according to claim 11, wherein classifying the given IP address comprises comparing the duration to first and second thresholds, classifying the given IP address as non-shared if the duration is less than or equal to the first threshold, and classifying the given IP address as shared if the number is greater than or equal to the second threshold.

13. The method according to claim 8, wherein the IP addresses comprise public IP addresses, and wherein a given feature comprises a number of local IP addresses detected from a given public IP address.

14. The method according to claim 13, wherein classifying the given IP address comprises comparing the number to a threshold, classifying the given IP address as non-shared if the number is less than or equal to the threshold, and classifying the given IP address as shared if the number is greater than the threshold.

15. The method according to claim 8, wherein a given feature comprises a number of days a given IP address was active.

16. The method according to claim 15, wherein classifying the given IP address comprises comparing the number to a threshold, classifying the given IP address as non-shared if the number is less than or equal to the threshold, and classifying the given IP address as shared if the number is greater than the threshold.

17. The method according to claim 8, wherein a given feature comprises a number of different operating systems detected from a given IP address.

18. The method according to claim 17, wherein classifying the given IP address comprises comparing the number to a threshold, classifying the given IP address as non-shared if the number is less than or equal to the threshold, and classifying the given IP address as shared if the number is greater than the threshold.

19. The method according to claim 8, wherein a given feature comprises a number of distinct hours of the day a given IP address was active.

20. The method according to claim 19, wherein classifying the given IP address comprises comparing the number to a threshold, classifying the given IP address as non-shared if the number is less than or equal to the threshold, and classifying the given IP address as shared if the number is greater than the threshold.

21. The method according to claim 8, wherein a given feature comprises a number of application server ports that had transmissions from a given IP address.

22. The method according to claim 21, wherein classifying the given IP address comprises comparing the number to a threshold, classifying the given IP address as non-shared if the identified number is less than or equal to the threshold, and classifying the given IP address as shared if the number is greater than the threshold.

23. The method according to claim 8, wherein a given feature comprises a number of cloud domains that had transmissions 36 to or from a given IP address.

24. The method according to claim 23, wherein classifying the given IP address comprises comparing the number to a threshold, classifying the given IP address as non-shared if the number is less than or equal to the threshold, and classifying the given public IP address as shared if the identified number is greater than the threshold.

25. The method according to claim 8, wherein a given feature comprises an amount of data transmitted to and received by a given IP address.

26. The method according to claim 25, wherein classifying the given IP address comprises comparing the amount to a threshold, classifying the given IP address as non-shared if the amount of data is less than or equal to the threshold, and classifying the given IP address as shared if the amount of data is greater than the threshold.

27. The method according to claim 8, wherein a given feature comprises a number of Domain Name System (DNS) queries, from a given public IP address, conveyed for different domains.

28. The method according to claim 27, wherein classifying the given IP address comprises comparing the number to a threshold, classifying the given IP address as non-shared if the number is less than or equal to the threshold, and classifying the given IP address as shared if the number is greater than the threshold.

29. An apparatus, comprising:
a memory configured to store a model; and
a processor configured:
to receive, from a set of first computing resources deployed at a plurality of first Internet Protocol (IP) addresses, first logs detailing events occurring on the first computing resources during a first time period,
to receive respective labels for the first IP addresses indicating whether each of the first IP addresses is shared or non-shared,
to train, based on the events during the first time period and the received labels, the model to classify the first IP addresses as either shared or non-shared,
to receive, from a set of second computing resources deployed at a plurality of second IP addresses, second logs detailing events occurring on the second computing resources during a second time period,
to apply the trained model to the events during the second time period so as to classify each of the second IP addresses as either shared or non-shared, the non-shared second IP addresses corresponding to respective second computing resources, and
upon detecting, in a given second log, one or more events indicating suspicious activity at a given non-shared second IP address, to initiate a protective action on the second computing resource corresponding to the given second non-shared IP address.

30. A computer software product, the computer software product comprising a non-transitory computer-readable medium, in which program instructions are stored, which instructions, when read by a computer, cause the computer:
to receive, from a set of first computing resources deployed at a plurality of first Internet Protocol (IP) addresses, first logs detailing events occurring on the first computing resources during a first time period;
to receive respective labels for the first IP addresses indicating whether each of the first IP addresses is shared or non-shared;
to train, by a processor based on the events during the first time period and the received labels, a model for classifying the first IP addresses as either shared or non-shared;
to receive, from a set of second computing resources deployed at a plurality of second IP addresses, second logs detailing events occurring on the second computing resources during a second time period;
to apply the trained model to the events during the second time period so as to classify each of the second IP addresses as either shared or non-shared, the non-shared second IP addresses corresponding to respective second computing resources; and
upon detecting, in a given second log, one or more events indicating suspicious activity at a given non-shared second IP address, to initiate a protective action on the second computing resource corresponding to the given second non-shared IP address.
